(19) United States
(12) Patent Application Publication
(10) Pub. No.: US 2026/0073436 A1
(43) Pub. Date: Mar. 12, 2026

(54) METADATA BASED STATEFUL RULE ENGINE

(71) Applicant: Constant Contact Inc., Waltham, MA (US)

(72) Inventors: Dennis Cammer, Waltham, MA (US); Zhong Chen, Waltham, MA (US)

(73) Assignee: Constant Contact Inc., Waltham, MA (US)

(21) Appl. No.: 19/317,107

(22) Filed: Sep. 2, 2025

Related U.S. Application Data
(60) Provisional application No. 63/689,710, filed on Aug. 31, 2024.

(51) Int. Cl. G06Q 30/0601

(52) U.S. Cl. CPC G06Q 30/0613

(57) ABSTRACT

A system for processing events for contacts, contains an event routes stateful object for determining if an event of the contact can be processed by the system, and a contact stateful object storing contact information therein and for receiving event types and attributes. The system dispatches the event with contact information for rule processing after which contact level rules are dispatched for execution. The system also contains a condition stateful object having stored therein conditions that a customer wishes to apply to specific events, a condition execution stateful object for evaluating contact level rules and a workflow stateful object for executing actions associated with the contact level rules.

### CROSS REFERENCE TO RELATED APPLICATIONS

The present application claims priority to US provisional patent application number 63/689,710, entitled “Meta Data Based Stateful Rule Engine”, filed on Aug. 31, 2024, which is incorporated herein by reference in its entirety.

### FIELD OF THE INVENTION

The present invention relates to customer event processing systems and methods, and more particularly, systems and methods for processing very high volumes of events in a highly efficient manner with minimum hardware.

### BACKGROUND OF THE INVENTION

The modern landscape of e-commerce is a vast and complex ecosystem. There are millions of transactions that take place within a single hour across countless platforms, each involving different combinations of contacts, products, services, and delivery options. This may be beneficial to the consumer and even to those selling products and services online, however, this has also created significant challenges in managing the many events that drive these transactions. From the browsing and adding of items and select services to carts, to the processing of payments, handling of returns, and managing of subscriptions, every action a contact takes online must be tracked, recorded, and responded to in real time. The volume of these events, compounded by their diversity, makes efficient handling increasingly difficult.

Complicating this further is the wide range of contact preferences that shape how transactions unfold. One customer may expect instant checkout with stored payment information, while another might prioritize flexible installment plans, or even another requiring new information, not previously stored, to be used for checkout. Adding to the complexity is the diversity of products and services offered online. A single platform might sell digital goods, physical merchandise, services, and subscription models, each governed by different rules, delivery mechanisms, and customer expectations.

The limitations of current transaction-handling methods becomes especially visible during peak activity periods, such as holiday sales or major online events. During these times, platforms often experience slowdowns, errors, or even crashes under heavy load. In these moments, the weaknesses of outdated systems become painfully clear: inflexible architecture, fragmented data handling, and a lack of real-time adaptability. As consumer expectations for speed, accuracy, and personalization continue to rise, the gap between what contacts demand and what current systems can deliver grows wider.

To address these challenges, a fundamentally new way of handling e-commerce events is required. A new way of handling such transactions is required to allow for the efficient and accurate processing of a higher volume of events in minimal time.

### SUMMARY OF THE INVENTION

The present system and method are described with regard to an ecommerce event. While this is the case, one having ordinary skill in the art would appreciate that the present system and method are not limited to ecommerce application.

A system for processing events for contacts if provided. The system contains an event routes stateful object for determining if an event of the contact can be processed by the system, and a contact stateful object storing contact information therein and for receiving event types and attributes. The system dispatches the event with contact information for rule processing after which contact level rules are dispatched for execution. The system also contains a condition stateful object having stored therein conditions that a customer wishes to apply to specific events, a condition execution stateful object for evaluating contact level rules and a workflow stateful object for executing actions associated with the contact level rules.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principals of the invention.

FIG. 1 is a schematic illustration of a network in which the present system and method may be located.

FIG. 2 is a schematic logic diagram exemplifying logical steps and portions of the present system in accordance with a first exemplary embodiment of the invention.

FIG. 3 is a flowchart illustrating steps taken by the present system and method of the present invention.

FIG. 4 is a flowchart further illustrating the method executed by the logic of FIG. 2 for a customer defining rules.

FIG. 5 is a schematic diagram illustrating parts of the application server of FIG. 1, in accordance with one exemplary embodiment of the invention.

### DETAILED DESCRIPTION

The present system and method are described with regard to a system and method for handling of ecommerce events. While this is the case, one having ordinary skill in the art would appreciate that the present system and method are not limited to ecommerce application, but instead, may be used for event handling of non-ecommerce events. Reference will now be made in detail to embodiments of the present invention, examples of which are illustrated in the accompanying drawings. Wherever possible, the same reference numbers are used in the drawings and the description to refer to the same or like parts.

The following definitions are useful for interpreting terms applied to features of the embodiments disclosed herein and are meant only to define elements within the disclosure.

As used within this disclosure, a “customer” refers to a party who engages with the present system and method, having at least one product or service online for selection and/or purchase, and who also has users/contacts.

As used within this disclosure, a “stateful object” refers to an entity that maintains and updates internal information (its “state”) across multiple interactions or events. Unlike stateless objects, which process each event independently without memory of past events, behavior of a stateful object or output of a stateful object can be influenced by its accumulated state.

As used within this disclosure, a “user” or “contact” refers to an individual who selects and/or purchases a product or service offered for sale by the customer. This would be, for example, the party who selects an ecommerce product online to purchase, causing the product to be directly sold online or placed in a cart due to the selection.

As used within this disclosure, a “client” refers to a device used by a contact to perform an action resulting in an event. A client is a device or program that requests services or resources from a server, such as, but not limited to, the application server of the present invention. Non-limiting examples of clients may include, but are not limited to, cellular telephones, laptop computers, desktop computers, iPads and tablets.

As used within this disclosure, a “node” refers to a computational unit or component. A node is connected to a network and can send, receive, and/or process information. One or more stateful objects may be located at a node.

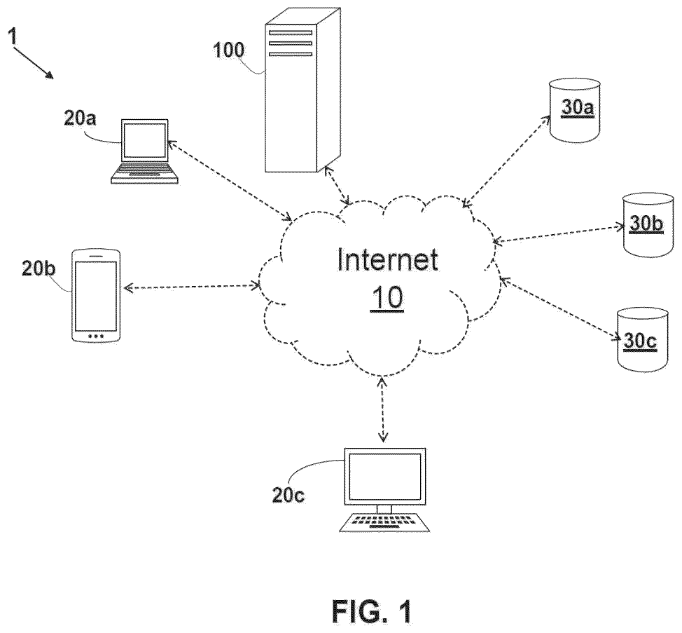

The present system and method may be provided in a network 1 illustrated by the schematic diagram of FIG. 1. An application server 100 may be located within the network 1, defining functionality performed by the present system and method, as will be described in detail herein. A contact performing an event, interacts with the present system and method by communicating with the application server 100 via the internet 10 through use of a user/contact device, also referred to herein as a client, such as, but not limited to a laptop 20a, a cell phone 20b, or a desktop computer 20c. Clients are used by contacts for interacting with the present system, and specifically, for performing events, such as, but not limited to, selecting and purchasing items or services of customers. The network 1 may contain multiple nodes, one of which is the present application server 100. The application server 100 contains one or more stateful objects. Functionality of different stateful objects is described in detail herein. It should be noted that the contact device 20 may be a different device, such as, but not limited to, an i-pad, smart watch, or other device.

As shown by FIG. 1, one or more database 30a-30c may be provided for storing data from and/or providing data to the application server 100, as described herein. While three databases are illustrated by FIG. 1, one having ordinary skill in the art will appreciate that fewer or more databases may be provided. It will also be appreciated that such remote storage may be cloud storage or another form of remote storage. It is noted that in accordance with a preferred embodiment of the invention, data, such as customer rules, predefined events, contact names and contact preferences, are stored within objects of the application server 100, however, such data may also be stored remote from the application server 100, within one or more database 30a-30c, which communicates with the application server 100.

In general, the present system and method receives a notification that an event has happened, determines who the contact using the system is and determines if there are rules for that contact specific to that event. Rules may be different for each specific contact, which can make this a complex process to manage. The present system and method address this complexity to allow for the processing of a high volume of events per second with minimum hardware. For example, the processing may be for thousands of events per second or more via stateful objects located within the application server 100 and in other nodes within the network.

In the example of an ecommerce purchase, the present system and method match the contact who made a purchase, to contact specific rules for a specific item purchased, previously defined within a stateful object of the system. The present system and method allow for distributing customer information of an ecommerce company through hardware, preferably, locally. Such information is preferably distributed between local stateful objects, where these stateful objects may be located within the same application server 100. Alternatively, certain stateful objects may be located separate from the application server 100, with customer information distributed to and from such stateful objects as described herein.

Information is transmitted within the application server 100 stating that this contact for this ecommerce company has this event, as an example, X was added to the cart for contact A. The message received by the present system and method has the information about the user/contact. With the information about the contact received, the present application server 100 has predefined rules stored and updated therein that can be applied to the situation. Instead of getting information from many different locations, the present system and method creates a path and sends the context that needs to be processed through the path, which includes different stateful objects having a specific task.

The present invention relates to the efficient processing of customer events, preferably, locally at an application server, and more particularly, is related to the processing of thousands of events per second, with minimum hardware and without traditional expensive external lookup.

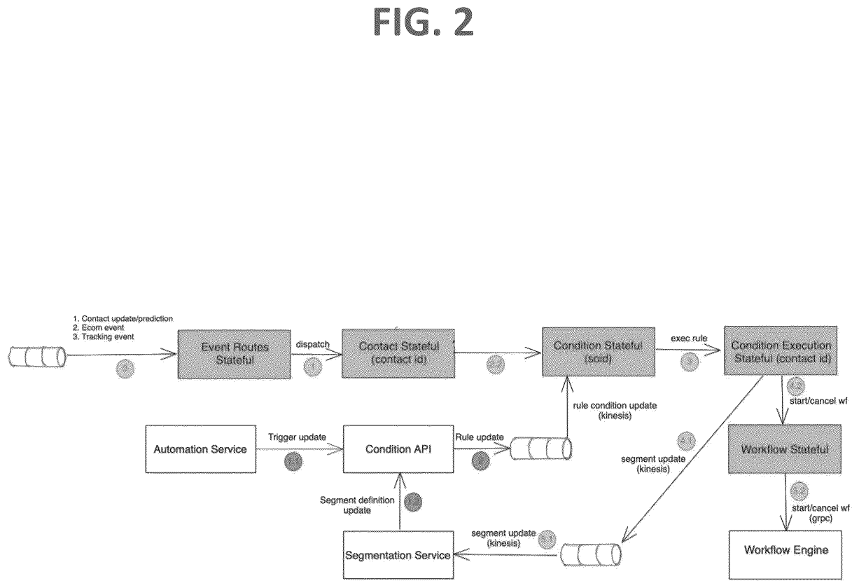

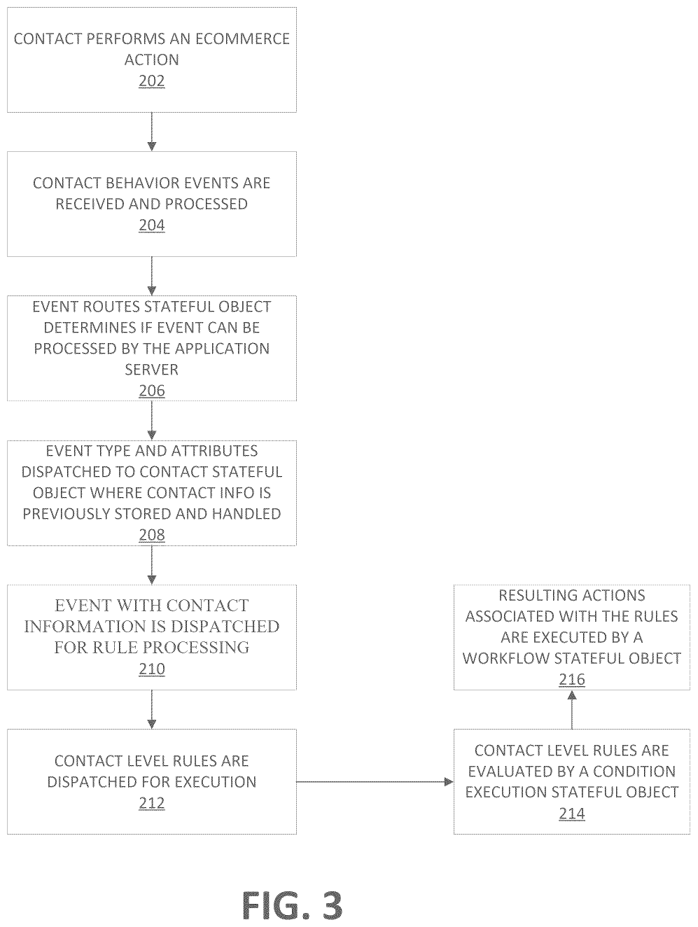

FIG. 2 is a schematic logic diagram exemplifying the present system in accordance with a first exemplary embodiment of the invention. FIG. 3 is a flowchart illustrating steps taken by the present system and method of the present invention in handling of an event. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The following description of the present system and method is provided referring to both FIG. 2, the logical diagram, and FIG. 3, the flowchart illustrating steps taken by the present method. As shown by block 202 in FIG. 3, a contact performs an ecommerce action, also referred to as an ecommerce event. As previously mentioned, an example of such an ecommerce event may be, but is not limited to, a contact adding an item to their online cart. Other events may include, but are not limited to, the opening of an email, the opening of a text message, and the joining of a campaign. The types of events could be in the millions or billions.

As shown by block 204 of FIG. 3, with contact performance of the ecommerce action, behavior events from a contact are received and processed by the present system and method. Specifically, as shown by FIG. 2, a message is received by the present system providing, for example, contact information, ecommerce event type, and tracking event information. It is noted, that not all three of these data points must be received for the present method to be used, but at least at least contact information and ecommerce event type is received by an event routes stateful object 302, preferably located within the application server 100 (FIG. 1).

As shown by block 206 of FIG. 3, the event routes stateful object 302 then determines if the customer-initiated event received, as reported by the received message, is an event that can be processed by the application server 100. The event routes stateful object 302 has stored therein specific event types or characteristics of event types that allow the event routes stateful object 302 to make this determination.

As shown by block 208 of FIG. 3, and point 1 in FIG. 2, the event type and attributes of the event are dispatched to a contact stateful object 304 (FIG. 2) where contact information is previously stored and handled. The contact stateful object 304 (FIG. 2) may determine if the contact information was previously stored therein and act accordingly. For example, if no such contact information was previously stored, such contact information may be stored therein or if such contact information does exist, the information may be updated if received contact information contains additional information that requires updating. The received event type and attributes of the event, when connected to a specific contact and its information, is stored with the contact information within the contact stateful object 304 (FIG. 2).

Information regarding the contact is gathered by the present system and may be stored locally or remotely, as well as updated. Preferably, the information is stored locally. As an example, an indication that the contact is interested in a specific product can be locally stored.

As shown by block 210 (FIG. 3) and point 2.2 of FIG. 2, the event with the contact information is then dispatched for rule processing by the application server 100 by sending this information to a condition stateful object 306 (FIG. 2). Based on the contact, the application server 100 determines what are the conditions that the customer wants to apply to the contact, specific to the event that has taken place. The conditions that the customer may wish to apply may be previously stored by the customer within a condition stateful object 306 of the application server 100 (FIG. 1), specific to a contact and/or an event.

As shown by block 212 (FIG. 3) and point 3 of FIG. 2, contact level rules are dispatched for execution. The contact level rules are the conditions that the customer wishes to apply for the specific contact and/or event. It should be noted that there may be multiple rules that could be executed, however, specific rules may be defined for specific customers and/or for specific events. The rules are defined by the customer and can be, for example, sending an email, sending a text message, offering another item or service, or one of many different actions as defined by the customer. In addition, multiple different actions may dispatched for execution. As previously mentioned, the contact level rules are predefined by the customer and stored within the condition stateful object 306 (FIG. 2).

Certain contact level rules may be based on time. For example, to send an email three days before the birthday of a contact, the present system and method may send a message to each of the customers to initiate processing for a new day. This message is then sent for each contact to execute date-based rules.

As shown by block 214 (FIG. 3) and points 4.1/4.2, the contact level rules are then evaluated by a condition execution stateful object 308 (FIG. 2). After evaluation of the rules, the resulting actions associated with the rules are executed by a workflow stateful object 310 (FIG. 2) (block 216, FIG. 3). In accordance with the present system and method, received information about the contact and events are collected and stored with the contact profile to have robust and detailed information regarding the contact.

Events are predefined by the customer and contact specific information may also be provided by the customer. It is noted, however, that if a new contact interacts with the present system and method, where that contact does not yet have a contact profile within the present system and method, a new contact profile may be created for that contact.

A unique contact profiling process is used by the present system and method. That contact profiling process works by using segmentation. Specifically, different groups of events may be stored together under a single category, where there are multiple categories. For example, one category may be ecommerce providers, where events that would be associated with an online sale may be stored within a category called ecommerce providers. As another example, a category called tracking service may exist where email and text tracking events may be defined and stored, such as the opening of an email or text message. These events are fed into the contact profile so that the locally stored contact profile is robust.

Customer specific rules are set up in a distributed manner on the present distributed system. Specifically, information regarding a customer is routed from outside systems, to the present system, reporting the customer information, which is then stored within a local customer profile. A rule engine of the present system then is used to execute defined rules that are specific to predefined events, as defined by the customer. Specifically, rules are defined locally to the present system and executed local to the present system.

The use of the present distributed system by the present system and method allows for the processing and execution of thousands of events per second for thousands of users/contacts of customers, when a single customer could have thousands of defined events.

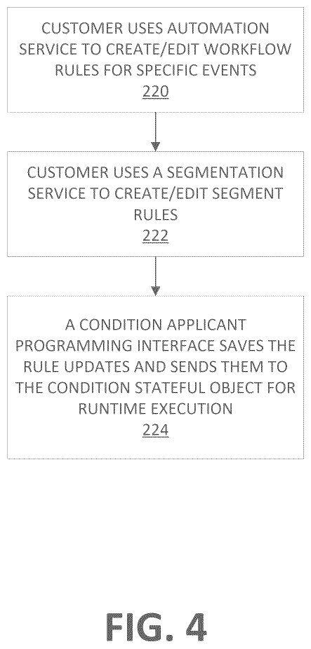

FIG. 2 also illustrates how a customer of the present system and method defines rules for specific events. FIG. 4 is a flowchart further illustrating the method of FIG. 2 for a customer defining rules.

As shown by block 220 of FIG. 4 and point 1.1 of FIG. 2, a customer may use an automation service to create/edit workflow rules for specific events. The automation service is a separate application from the applications server 100 of the present invention, and may run on a different and separate application server. The automation service manages automations for customers. For instance, if a customer would like to send an email when an item is left in a shopping cart, they configure an automation. This may include setting up a trigger, which is the rule that specifies when the workflow should run, for example, when an item is left in a shopping cart. A workflow rule defines when to start an automatic handling of events.

As shown by block 222 of FIG. 4 and point 1.2 of FIG. 2, the customer uses a segmentation service to create/edit segment rules. A segment is a way of grouping contacts/users by a rule. Segmentation is a feature of the present invention which is offered to customers of the present system and method. For example, if a customer wants to notify people living in Nashua, New Hampshire, that a food truck will be there this week, they can create a “segment” of contacts who reside in Nashua and then send an email to that segment about the food truck. The present system and method allows customers to create segments based on various tracked characteristics, such as contact properties (birthdays, anniversaries, addresses, customer defined properties, etc.) , behavior (e.g., contact opened an email, clicked a link), or a combination of these. These are non-limiting examples and the present system and method is not limited to these examples. These define the rules for the condition service. When a segment is created or updated, it triggers the evaluation of contact states (i.e., the execution of these rules) for any contacts that may be impacted by the change.

As shown by block 224 of FIG. 4, as well as point 2 of FIG. 2, a condition applicant programming interface saves the rule updates and sends them to the condition stateful object for runtime execution.

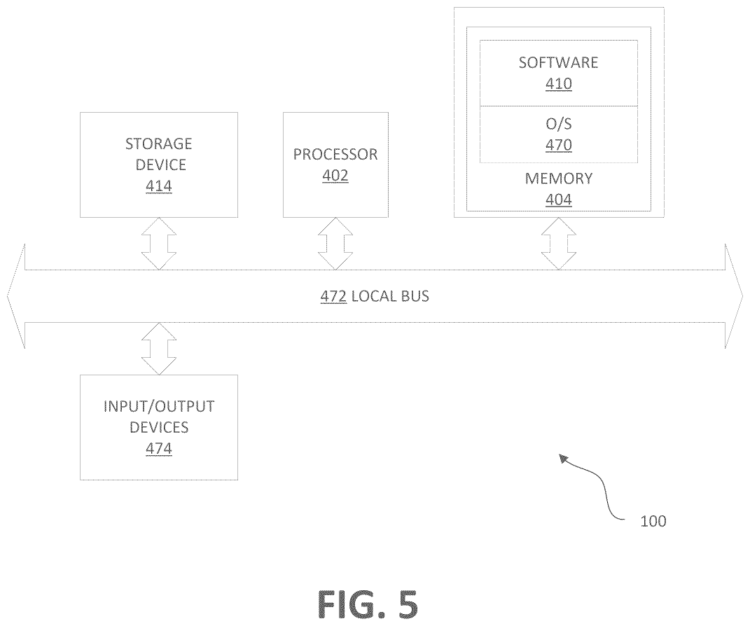

Functionality as performed by the present system and method is defined by modules/objects within the application server 100. The modules may be provided together as an application server 100 consisting of the modules/objects, or in multiple locations within a single or more than one machine, communicating when necessary to provide the present system and method. FIG. 5 is a schematic diagram illustrating parts of the application server 100, in accordance with one exemplary embodiment of the invention.

In accordance with one exemplary embodiment of the invention, the application server 100 which executes the functionality described in detail above, may have the physical part and logic of a computer. The application server 100 may contain a processor 402, a storage device 414, a memory 404 having software 410 stored therein that defines the above-mentioned functionality, input, and output (I/O) devices (or peripherals) 474, and a local bus 472, or local interface allowing for communication within the system 100. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software, particularly that stored in the memory. The processor can be any custom made or commercially available single core or multi-core processor, a central processing unit (CPU), an auxiliary processor among several processors associated with the present system, a semiconductor based microprocessor (in the form of a microchip or chip set), a macro processor, or generally any device for executing software instructions.

The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remotely from one another, but can be accessed by the processor.

The software defines functionality performed by the system, in accordance with the present invention. The software in the memory may include one or more separate programs, each of which contains an ordered listing of executable instructions for implementing logical functions of the system, as described below. The memory may contain an operating system (O/S). The operating system essentially controls the execution of programs within the system and provides scheduling, input-output control, file and data management, memory management, and communication control and related services.

The I/O devices may include input devices, for example but not limited to, a keyboard, mouse, scanner, microphone, etc. Furthermore, the I/O devices may also include output devices, for example but not limited to, a printer, display, etc. Finally, the I/O devices may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system is in operation, the processor is configured to execute the software stored within the memory, to communicate data to and from the memory, and to generally control operations of the system pursuant to the software, as explained above.

When the functionality of the system is in operation, the processor is configured to execute the software stored within the memory, to communicate data to and from the memory, and to generally control operations of the system pursuant to the software. The operating system is read by the processor, perhaps buffered within the processor, and then executed.

When the system is implemented in software, it should be noted that instructions for implementing the system can be stored on any computer-readable medium for use by or in connection with any computer-related device, system, or method. Such a computer-readable medium may, in some embodiments, correspond to either or both the memory or the storage device. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system is implemented in hardware, the system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A system for processing events for contacts, comprising
an event routes stateful object for determining if an event of the contact can be processed by the system;
a contact stateful object storing contact information therein and for receiving event types and attributes;
a condition stateful object having stored therein conditions that a customer wishes to apply to specific events;
a condition execution stateful object for evaluating contact level rules; and
a workflow stateful object for executing actions associated with the contact level rules.

2. The system for processing events for contacts of claim 1, wherein a contact who made a purchase is matched with at least one contact specific rule for a specific item, previously defined within the stateful object.

3. The system for processing events for contacts of claim 1, wherein the contact stateful object is configured to determine if the contact information was previously stored therein, and the contact information is configured to be updated if received contact information contains additional information.

4. The system for processing events for contacts of claim 1, wherein contact information may be stored locally or remotely.

5. The system for processing events for contacts of claim 1, wherein specific rules are defined for specific customers and/or for specific events.

6. The system for processing events for contacts of claim 1, wherein the contact level rules are predefined by the customer.

7. The system for processing events for contacts of claim 1, wherein the customer information is routed from an outside system to the present system, and reports the customer information to a local customer profile.

8. The system for processing events for contacts of claim 1, further comprising a segment which groups contacts by a rule.

9. The system for processing events for contacts of claim 1, further comprising a segmentation service which is configured to edit or create segment rules.

10. The system for processing events for contacts of claim 1, wherein the event routes stateful object, the contact stateful object, the condition stateful object, the condition execution stateful object for evaluating contact level rules, and the workflow stateful object are located within an application server.

11. The system for processing events for contacts of claim 1, wherein the contact level rules are based on time.

12. A method for processing events for contacts on an application server, comprising:
receiving a notification that an event occurred, wherein the event was triggered by a contact;
determining the contact who triggered the event via a contact stateful object;
determining whether at least one contact level rule for the contact applies to the event triggered via a condition execution stateful object, wherein the at least one contact level rule is configured to be different for each contact; and
applying the at least one contact level rule to the event.

13. The method for processing events for contacts on an application server of claim 12, wherein a customer's information can be distributed through at least one stateful object within the application server.

14. The method for processing events for contacts on an application server of claim 12, wherein a customer's information is configured to be distributed through at least one stateful object outside the application server.

15. The method for processing events for contacts on an application server of claim 12, wherein a customer's information is configured to be distributed through a hardware.

16. The method for processing events for contacts on an application server of claim 12, wherein the application server has predefined the at least one contact level rules stored and updated the at least one contact level rules that can be applied to the situation.

17. The method for processing events for contacts on an application server of claim 12, further creating a path comprised of at least one stateful object with a specific task, that sends a context processed through the path.

18. The method for processing events for contacts on an application server of claim 12, wherein the contact triggers the event by actions including adding an item to their online cart, opening an email, opening a text message, and joining a campaign.
